(19) United States
(12) Patent Application Publication
(10) Pub. No.: US 2005/0096427 A1
(43) Pub. Date: May 5, 2005

(54) Ultraviolet radiation curable clearcoat composition with low color and good durability

(75) Inventors: Michelle Odajima, Toledo, OH (US); David W. Braun, Whitehouse, OH (US)

Correspondence Address: BASF CORPORATION;ANNE GERRY SABOURIN, 26701 TELEGRAPH ROAD, SOUTHFIELD, MI, 48034-2442, US

(73) Assignee: BASF AG,, Ludwigshafen (DE)

(21) Appl. No.: 10/978,495

(22) Filed: Nov. 1, 2004

Related U.S. Application Data
(60) Provisional application No. 60/516,389, filed on Oct. 31, 2003.
(60) Provisional application No. 60/541,517, filed on Feb. 2, 2004.

(51) Int. Cl. C08K 5/05; C08K 5/34; C08G 2/00

(52) U.S. Cl. 524/755; 522/33; 524/765

(57) ABSTRACT

The present invention defines a one-component low color clearcoat curable under ultraviolet (UV) light, a method for obtaining low color and good weather durability in a clearcoat coating composition and a method for obtaining a coated substrate with a low color clearcoat. When the composition is applied and cured with sufficient exposure to UV radiation, a low color clearcoat providing a hard coating, resistant to chemicals and weathering is obtained.

This application claims the benefit of application of provisional applications having U.S. Ser. No. 60/516,389, filed on Oct. 31, 2003 and 60/541,517, filed on Feb. 2, 2004, all of which are hereby incorporated by reference.

Clearcoat compositions for basecoat/clearcoat coatings have been used in vehicle finishing since the 1970's. The clearcoat is the final coating layer and generally functions to impart gloss and provide weathering protection. Clearcoat compositions should provide transparency, low color and gloss. The coating process often involves applying layers of primer, basecoat and clearcoat to a substrate. It is important that the clearcoat does not have color following curing. Color in a clearcoat creates difficulty in matching the color of an underlying basecoat in a refinish coating application. Additionally, color in a clearcoat may cause a white basecoat underlying the clearcoat to appear yellow or brown tinged. Clearcoat compositions curable by ultraviolet (UV) radiation typically present a yellowing problem upon curing with UV radiation.

The present invention provides a one-component clearcoat coating composition curable with ultraviolet radiation that provides low color initially after application, as well as after full cure of the coating and a method for obtaining a low color clearcoat. The invention also provides a clearcoat coating composition that provides good resistance to weathering degradation by providing gloss retention and low delta E values.

### SUMMARY OF THE INVENTION

The present invention defines a one-component, low color clearcoat curable with ultraviolet (UV) radiation that provides good durability and low color upon exposure to weathering. The clearcoat must include at least one of solvent, initiator, UVA and HALS that promote low color and provide durability.

The invention further includes a method for obtaining low color in a clearcoat coating composition and a method for obtaining a coated substrate with a low color clearcoat that has good weathering durability. When the composition is applied, the clearcoat has low color and the underlying basecoat color can be accurately matched. Following curing of the clearcoat upon sufficient exposure to UV radiation according to the invention, a low color clearcoat providing a hard coating, resistant to chemicals, deterioration, and discoloration caused by weather exposure is obtained.

### DETAILED DESCRIPTION

This invention relates to a clearcoat composition providing little or no color, a method of lowering color in a UV curable clearcoat and a method of applying a clearcoat composition to a substrate. The UV radiation curable clearcoat comprises at least one compound selected from the group consisting of A) 0.1-99.90% by weight of one or more compounds comprising acrylate or methacrylate monomers or mixtures thereof having from one to six free-radically polymerizable groups per molecule and B) 0.1 to 99.9% by weight of one or more compounds containing two or more ethylenically unsaturated, free radically polymerizable groups per molecule and mixtures thereof, and mixtures of A) and B). The coating further comprises compounds selected from the group consisting of C) from 0.1 to 10.0% by weight of one or more photoinitiators; D) 5-70% by weight of volatile organic solvent(s) selected from the group consisting of alcohols, ether alcohols, ether esters, propionates and mixtures thereof and E) 1-15% by weight of customary additives, at least one of which is a UVA and/or HALS.

In one embodiment the clearcoat contains A) 0 to 50% by weight of one or more compounds comprising acrylate or methacrylate monomers or mixtures thereof having from 1 to 6 free-radically polymerizable groups per molecule; B) 30 to 99.9% by weight of one or more compounds containing two or more ethylenically unsaturated, free radically polymerizable groups per molecule selected from the group consisting of urethane acrylates and methacrylates, polyester acrylates and methacrylates, melamine, acrylic amine, cellulose based acrylates and methacrylates and unsaturated polyesters; C) from 1 to 10% by weight of one or more photoinitiators; D) up to 69.9% by weight of volatile organic solvent and; E) up to 10% by weight of customary additives. In general, the type and level of component A is chosen to impart hardness, fast cure and higher solids. The choice and level of component B is chosen to provide flexibility, adhesion and higher solids. Preferably the ethylenically unsaturated groups in component A and component B are principally acrylate groups as these provide a rapid cure rate.

Examples of compounds suitable as component A include monoacrylate monomers such as octyl-decyl monoacrylate, isobornyl monoacrylate and isodecyl monoacrylate, diacrylate monomers such as hexanediol diacrylate or tripropyleneglycol diacrylate, triacrylates such as trimethylolpropane triacrylate, alkoxylated trimethylolpropane triacrylate or pentaerythritol triacrylate, polyacrylates such as pentaerythritol tetraacrylate pentaerythritol pentaacrylate or dipentaerythritol hexaacrylate, and mixtures of any of the above.

Examples of compounds suitable as component B include compounds selected from the group consisting of urethane acrylates, polyester acrylates and methacrylates, melamine, acrylic amine, cellulose based acrylates and methacrylates and unsaturated polyesters and mixtures thereof. Urethane acrylate include, but are not limited to compounds such as Ebecryl 8402, Ebecryl 5129, or Ebecryl 1290 and Ebecryl 8301, available from UCB chemicals or Actilane 251, Actilane 270, Actilane 276 and Actilane 280 available from Akcros Chemicals or CN 292 from Sartomer Company. Preferably component B comprises one or more urethane acrylates, or one or more polyester acrylates or mixtures thereof.

Component C can be one or more photoinitiators including but not limited to alpha hydroxyl ketones, alpha amino ketones and acyl phosphine oxides and mixtures of any of these. Examples of suitable photoinitiators include but are not limited to 1-hydroxy-cyclohexyl-phenyl ketone, 2-hydroxy-2-methyl-1-phenyl-propan1-one, 2,4,6-trimethylbenzoyl-diphenylphosphine oxide, 2-methyl-1-[4-(methylthio)phenyl]-2-morpholino-propan-1-one, and poly[2-hydroxy-2-methyl-1-[4-(1-methylvinyl)phenyl]propan-1-one], methylbenzophenone derivatives, and mixtures thereof.

The photoinitiators are sold commercially as Irgacure® 1000, a mixture of 1-hydroxy-cyclohexyl-phenyl ketone and 2-hydroxy-2-methyl-1-phenyl-propan1-one from Ciba-Geigy; 2-hydroxy-2-methyl-1-phenyl-propan1-one sold under the name Irgacure® 1173; 1-hydroxy-cyclohexyl-phenyl ketone sold under the name Irgacure®184; a blend of 2,4,6-trimethylbenzoyl-diphenylphosphine oxide and 2-hydroxy-2-methyl-1-phenyl-propan1-one sold as Darocur® 4265 by Ciba-Geigy; a mixture of poly [2-hydroxy-2-methyl-1-[4-(1-methylvinyl)phenyl]propan-1-one] and 2,4,6-trimethylbenzoyl-diphenylphosphine oxide and methylbenzophenone derivatives sold under the name KTO46 by Esacure; and 2,4,6-trimethylbenzoyl-diphenyl-phosphine oxide sold as Lucirin® TPO by BASF; 2,4,6-trimethylbenzoyl-ethoxyphenyl-phosphine oxide sold as Lucirin® TPO-L by BASF and bis(2,4,6-trimethylbenzoyl)-phenyl-phosphine oxide sold as Irgacure 819 by Ciba-Geigy.

The volatile organic solvent D) must be selected to provide low color or no color in the clearcoat. The solvent should be effective to adjust the viscosity of the coating composition. The solvent is at least one of alcohol, ether alcohol, ether ester and propionate ester solvents. Preferably the solvent is selected from the group consisting of n-butyl propionate, n-propyl propionate, secondary butyl alcohol, isopropyl alcohol, propylene glycol methyl ether, propylene glycol tert-butyl ether, propylene glycol ethyl ether and mixtures thereof. Solvents such as alcohols frequently provide very low color but depending on the resin utilized in the coating may not be as effective to reduce the viscosity of the coating composition. More alcohol may be required to achieve the same viscosity as for example an ester or an ether alcohol solvent, resulting in higher volatile organic content (voc). Solvents such as propionate esters and ether esters are higher in color but provide viscosity reduction in lower quantities than alcohols. Accordingly, it has been found that mixtures of alcohols and ether alcohols or propionates and ether alcohols are useful in providing low color coating compositions with acceptable levels of voc. One example of a suitable mixture of solvents includes N-propyl propionate and propylene glycol methyl ether, or n-propyl propionate and sec-butyl alcohol. Mixtures of these solvents in a ratio of between 0.5:1 to 1:1.5 provided good results in low color upon cure and after weathering in the clearcoat.

Solvents such as ketones and acetates are not utilized in the present invention as use of these solvents result in unacceptable levels of color upon cure and after weathering in the clearcoat composition.

The clearcoat composition also contains one or more conventional additives E) such as photosynergists, ultraviolet absorbers, hindered amine light stabilizers, adhesion promoters, flow aids, wetting aids and rheology modifiers. Component E) includes at least one ultraviolet absorber (UVA) or hindered amine light stabilizer (HALS) that provide minimal color in a cured clearcoat. Suitable UVAs include compounds such as triphenyltriazines such as Tinuvin® 400, a mixture of 2-[4-((2-hydroxy-3-dodecyloxypropyl)-oxy]-2-hydroxyphenyl]-4,6-bis(2,4-dimethylphenyl)-1,3,5-triazine and 2-[4-((2-hydroxy-3-tridecyloxypropyl)-oxy]-2-hydroxyphenyl]-4,6-bis(2,4-dimethylphenyl)-1,3,5-triazine sold by Ciba Geigy, and 2-[4,6-bis(2,4-dimethyphenyl-1,3,5-trazin-2-yl]-5-(octyl) phenol sold as Cyasorb® UV-1164 by Cytec; or oxalic acid anilides such as N-(2-ethoxyphenyl)-N′-(2-ethylphenyl)-ethanediamide sold as Sanduvor® VSU by Clariant, and N-(2-ethoxyphenyl)-N′-(4-isododecylphenyl)-ethanediarriide sold as Sanduvor® 3206 by Clariant. Another suitable UVA is propanedioic acid, [(4-methoxyphenyl)methylene]-,dimethyl ester sold as Hostavin® PR-25 by Clariant. Suitable HALS include 2,2,6,6-tetramethyl piperidine based HALS such as N-(1-acetyl-2,2,6,6-tetramethyl-4-piperidinyl)-2-dodecylsuccinimide sold as Sanduvor® 3058; 3-dodecyl-1-(2,2,6,6-tetramethyl-4-piperidinyl)-2,5-pyrrolidinedione sold as Sanduvor® 3055; propanedioic acid, [(4-methoxyphenyl) methylene]-,bis(1,2,2,6,6-tetramethyl-4-piperidinyl) ester sold as Hostavin® PR31 and a blend of 7-oxa-3,20-diazadispiro[5.1.11.2]heneicosane-20-propanoic acid, 2,2,4,4-tetramethyl-21-oxo-, dodecyl ester and 7-oxa-3,20-diazadispiro[5.1.11.2]heneicosane-20-propanoic acid, 2,2,4,4-tetramethyl-21-oxo-, tetradecyl ester sold as Sanduvor® 3050, all by Clariant; and decanedioic acid, bis(,2,2,6,6-tetramethyl-1-(octyloxy)-4-piperidinyl ester, reaction products with 1,1-dimethlyethylhydroperoxide and octane sold as Tinuvin® 123 and a mixture of bis(1,2,2,6,6-tetramethyl-4-piperidinyl)-sebacate and 1-(methyl)-8-(1,2,2,6,6-tetramethyl-4-piperidinyl)-sebacate sold as Tinuvin® 292, both by Ciba.

A method of lowering color in a clearcoat composition, comprises forming a clearcoat composition that is curable by ultraviolet radiation by combining components A)-E) of the description and in the amounts set forth herein above.

The clearcoat is applied over any primer and or basecoat system in order to achieve the desired final color and appearance. For example the clearcoat can be coated over a waterborne basecoat such as 90-Line available from BASF Corporation or a solvent-borne basecoat such as 55-Line available from BASF Corporation. The coating is applied by means such as brush, roller, sponge, spray gun or aerosol, preferably spray gun or aerosol. The substrate can be for example metal, plastic, wood or glass. A suitable dry film thickness ranges from 5 to 125 microns, preferably, from 5 to 75 microns.

The clearcoat is exposed to ultraviolet radiation provided by one or more UV lamps delivering an irradiance level of 0.01 to 200 mW/cm² to the coating for a time between 1 second and 30 minutes. An irradiance level of 1 to 100 mW/cm² to the coating for a time between 30 seconds and 10 minutes may be used to obtain a tack free surface. The irradiance is given in the UVA range with following ratios—UVV:UVA of 1:1 or less, UVB:UVA 1:1 or less, UVC:UVA of 1:1 or less. The wavelengths may also be UVV:UVA 1:1 or less, UVB: UVA 1:1 or less, with substantially no UVC. In one embodiment, the irradiances levels are UVV:UVA 0.5:1 or less, UVB:UVA 0.5:1 or less, with substantially no UVC. In another embodiment, the irradiance levels are UVV:UVA 1:1 or less or UVA only, with substantially no UVC and UVB.

UV radiation includes UVA radiation which is any radiation falling within the 320-400 nm wavelength interval, UVB radiation, which is any radiation falling within the 280-320 nm wavelength, UV-C radiation, which is any radiation falling within the 100-280 nm wavelength interval and UVV radiation is any radiation falling within the 400-750 nm wavelength interval. The color of the clearcoat is then read with a portable spectrophotometer immediately after curing and again one hour later. The color was compared to Diamont DC92, a commercial 2K urethane clearcoat of known good color characteristics. Cured color was recorded as db*. Higher db* indicates more yellow color than the standard. The desired db* is between a value of 0 and 2.0. The desired weatherability of the coating is a minimum exposure of 3300 kJ/m² prior to failure under weatherometer testing conditions under test conditions specified in SAE J1960.

The method described above provides a clearcoat composition with WOM results of at least 3300 kJ/m² testing before failure, under SAE J1960 test procedures.

According to the present invention there is a process provided for coating a coated or partially coated substrate, a spot repair application, OEM automotive paint applications, and other transportation vehicle paint applications.

The invention is illustrated by means of the following examples.

### EXAMPLES

### Example 1

Clearcoat formulae:

| Samples | | | | | | |
|---|---|---|---|---|---|---|
| 1 | 2 | 3 | 4 | 5 | 6 | 7 |

| | |
|---|---|
| Ingredient | Amount (grams) |

| | | | | | | | |
|---|---|---|---|---|---|---|---|
| NPP¹ | 14.1 | 14.1 | 19.45 | 19.45 | 19.45 | 19.45 | 14.24 |
| DPM² | 14.1 | 14.1 | 19.45 | 19.45 | 19.45 | 19.45 | 14.24 |
| Byk 325⁴ | 0.4 | 0.4 | 0.15 | 0.15 | 0.15 | 0.15 | 0.41 |
| Byk 358⁵ | 0.24 | 0.24 | 0.26 | 0.26 | 0.26 | 0.26 | 0.24 |
| Tin 292⁶ | 0.72 | 0.72 | 0 | 0.875 | 0.875 | 0 | 0.72 |
| Tin 400⁷ | 0.48 | 0.48 | 0 | 0 | 0 | 0 | 0.48 |
| Sanduvor | 0 | 0 | 0 | 0 | 0 | 0.88 | 0 |
| 3058⁸ | | | | | | | |
| Sanduvor | 0 | 0 | 0 | 0 | .44 | .44 | 0 |
| 3206¹⁰ | | | | | | | |
| EB 8405⁹ | 26.4 | 48.0 | 0 | 0 | 0 | 0 | 0 |
| Experimental | 21.6 | 0 | 43.78 | 43.78 | 43.78 | 43.78 | 31.2 |
| urethane | | | | | | | |
| triacrylate | | | | | | | |
| SR 399 LV¹¹ | 0 | 0 | 14.58 | 14.58 | 14.58 | 14.58 | 0 |
| Irg 184¹² | 1.6 | 1.6 | 1.95 | 1.95 | 1.95 | 1.95 | 0 |
| Irg 819¹³ | 0.32 | 0.32 | 0.38 | 0.38 | 0.38 | 0.38 | 0 |
| Experimental | 0 | 0 | 0 | 0 | 0 | 0 | 7.2 |
| urethane | | | | | | | |
| decaacrylate | | | | | | | |
| ODA_N¹⁵ | 0 | 0 | 0 | 0 | 0 | 0 | 9.6 |

¹N-propyl propionate solvent
²Propylene glycol monomethyl ether solvent
⁴BYK 325 is a rheology control agent available from Byk Chemie.
⁵Byk 358 is a rheology control agent available from Byk Chemie.
⁶Tinuvin 292 is a mixture of bis(1,2,2,6,6-tetramethyl-4-piperidinyl)-sebacate and 1-(methyl)-8-(1,2,2,6,6-tetramethyl-4-piperidinyl)-sebacate.
⁷Tinuvin 400 is a mixture of 2-[4-((2-hydroxy-3-dodecyloxypropyl)-oxy]-2-hydroxyphenyl]-4,6-bis(2,4-dimethylphenyl)-1,3,5-triazine and 2-[4-((2-hydroxy-3-tridecyloxypropyl)-oxy]-2-hydroxyphenyl]-4,6-bis(2,4-dimethylphenyl)-1,3,5-triazine sold by Ciba Geigy.
⁸Sanduvor 3058 is N-(1-acetyl-2,2,6,6-tetramethyl-4-piperidinyl)-2-dodecylsuccinimide
⁹EB 8405 is a urethane tetraacrylate monomer available from UCB Chemicals.
¹⁰Sanduvor 3206 is N-(2-ethoxyphenyl)-N′-(4-isododecylphenyl)-ethanediamide
¹¹SR 399LV is a dipentaerythritol pentaacrylate monomer available from Sartomer.
¹²rgacure 184 is 1-hydroxy-cyclohexyl-phenyl ketone from Ciba Geigy
¹³Irgacure 819 is bis(2,4,6-trimethylbenzoyl)-phenyl-phosphine oxide from Ciba Geigy.
¹⁵ODA-N is a monoacrylate monomer commercially available from UCB

Procedure: The samples were sprayed to 2 mil thickness in 2 coats using a HVLP spray gun over a white basecoat. The coatings were cured under a Panacol® 450 lamp fitted with a clear filter. The clears were irradiated four minutes at a distance of ten inches from the filter glass. The color was read with a portable spectrophotometer immediately after curing and again one hour later. The color was compared to Diamont® DC92, a commercial 2K urethane clearcoat of known good color characteristics. Yellowing difference was recorded as delta b*. Higher delta b* indicates more yellow color than the standard. Yellowing and Weathering results are set forth in Table 1.

TABLE 1
Color and Weathering Results Samples 1-6

| EXAMPLE | 1 | 2 | 3 | 4 | 5 | 6 |
|---|---|---|---|---|---|---|
| Initial Color | 0.54 | 0.68 | 0.7 | 0.73 | 1.1 | 0.9 |
| (delta E) | | | | | | |
| delta E after | 0.8 | 0.5 | 0.6 | 0.6 | 1.8 | 1.1 |
| WOM | | | | | | |
| exposure | | | | | | |
| Gloss (initial) | 82.9 | 86.4 | 81.6 | 82.5 | 81.5 | 83.5 |
| Gloss | 75.6 | 79.1 | 76.9 | 86.8 | 78 | 71.8 |
| After | | | | | | |
| exposure | | | | | | |
| Kj/m² of | 4900 | 4900 | 4500 | 4500 | 4500 | 5154 |
| exposure | | | | | | |

### Example 2

Clearcoats were prepared using various solvents together with photoinitiators without uva/hals additives and comprared for yellowing. Clearcoat formulations are as follows:

Clearcoat Formula

| Ingredient | Amounts |
|---|---|
| Solvent | 6.00 grams |
| Byk 325² | 0.045 grams |
| Irgacure 184³ | 0.30 grams |
| Irgacure 819⁴ | 0.06 grams |
| SR 399⁵ | 2.30 grams |
| Urethane triacrylate | 6.70 grams |

²BYK 325 is a rheology control agent available from Byk Chemie
³Irgacure 184 is 1-hydroxy-cyclohexyl-phenyl ketone from Ciba Geigy
⁴Irgacure 819 is bis(2,4,6-trimethylbenzoyl)-phenyl-phosphineoxide from Ciba Geigy
⁵Byk 358 is a rheology control agent available from Byk Chemie
⁶SR 399 is dipentaerythritol pentaacrylate monomer, available from Sartomer.

Procedure: Clearcoat as described in Example 2 was spray applied in two coats with a HVLP spray gun over a substrate coated with a white refinish basecoat. The first clearcoat application was flash dried for five minutes then a second application was applied and flash dried for five minutes and then the clearcoat was exposed to ultraviolet radiation under a Panacol 450 lamp fitted with a clear filter. The clearcoat was irradiated four minutes at a distance of ten inches from the filter glass. The color was read with a portable spectrophotometer immediately after curing and again one hour later. The color was compared to Diamont DC92, a commercial 2K urethane clearcoat of known good color characteristics. Color difference was recorded as db*. Higher db* indicates more yellow color than the standard. Yellowing results are set forth below in Table 2.

TABLE 2
Yellowing as a Function of Solvent Selection

| | Color - initial | Color - One hour |
|---|---|---|
| Solvent | after cure* | after cure* |
| n-propyl | 1.1 | 0.4 |
| propionate | | |
| Sec-butyl alcohol | 0.7 | 0.2 |
| propylene glycol | 0.5 | 0.1 |
| methyl ether | | |
| n-propyl | 1.0 | 0.4 |
| propionate/ | | |
| propylene glycol | | |
| methyl ether 1/1 | | |
| n-propyl | 0.4 | 0.0 |
| propionate/sec- | | |
| butyl alcohol 1/1 | | |

Delta b* as compared to Diamont DC92, a commercial 2K urethane clearcoat

### Example 3

A coating composition was prepared from the following formulation and tested with the solvent ladder described below. The color effect of the solvent on the clearcoat is recorded in Table 3.

Clearcoat Formulation:

| | |
|---|---|
| Resin¹ | 30 g |
| Solvent² | 20 g |
| Byk 325³ | 0.15 g |
| Byk 358⁴ | 0.255 g |
| Irg 184⁵ | 1.0 g |
| Irg 819⁶ | 0.2 g |

¹Resin is a 50/50 mixture of CN 133 aliphatic triacrylate oligomer from Sartomer and Experimental urethane triacrylate monomer.
²Solvents described in Table 3
³BYK 325 is a rheology control agent available from Byk Chemie.
⁴Byk 358 is a rheology control agent available from Byk Chemie.
⁵Irgacure 184 is 1-hydroxy-cyclohexyl-phenyl ketone from Ciba Geigy
⁶Irgacure 819 is bis(2,4,6-trimethylbenzoyl)-phenyl-phosphine oxide from Ciba Geigy.

TABLE 3

| | | Color |
|---|---|---|
| | Color | after |
| Solvent | (Initial)* | 1 hour* |
| Acetone | 1.79 | 1.1 |
| methyl ethyl ketone | 2.1 | 3.7 |
| methyl isobutyl ketone | 1.7 | 0.48 |
| Methyl acetate | 1.83 | 1.24 |
| n-butyl acetate | 1.71 | 1.01 |
| propylene glycol monomethyl ether | 1.01 | 0.65 |
| acetate | | |
| secondary Butyl alcohol | 1.3 | 1.16 |
| isopropyl alcohol | 1.57 | 1.21 |
| Oxsol 100 | 1.78 | 1.19 |

*delta E compared to Diamont DC92, a commercial 2K urethane clearcoat

1. A clearcoat coating composition for curing by ultraviolet radiation, comprising
A)0-50.00% by weight of one or more compounds comprising acrylate or methacrylate monomers or mixtures thereof having from one to six free-radically polymerizable groups per molecule,
B) 30 to 99.9% by weight of one or more compounds containing two or more ethylenically unsaturated, free radically polymerizable groups per molecule and mixtures thereof, and mixtures of A) and B)
C) 0.1 to 10.0% by weight of one or more photoinitiators selected from the group consisting of alpha hydroxyl ketones, alpha amino ketones and bis-acyl phosphine oxides and mixtures thereof; and
D) 0-69.9% by weight of volatile organic solvent(s) selected from the group consisting of alcohols, ether alcohols, ether esters, propionates and mixtures thereof.

2. A coating composition according to claim 1, further comprising 1-10% by weight of customary additives, including UVA and/or HALS selected from the group consisting of triphenyltriazines, oxalic acid anilides, 2,2,6,6-tetramethyl piperidine based HALS and mixtures thereof.

3. A coating composition according to claim 1 wherein compound C) is selected from the group consisting of 1-hydroxy-cyclohexyl-phenyl ketone, 2-hydroxy-2-methyl-1-phenyl-propan1-one, 2,4,6-trimethylbenzoyl-diphenylphosphine oxide, a blend of 2,4,6-trimethylbenzoyl-diphenylphosphine oxide and 2-hydroxy-2-methyl-1-phenyl-propan1-one and poly[2-hydroxy-2-methyl-1-[4-(1-methylvinyl)phenyl]propan-1-one], 2,4,6-trimethylbenzoyl-ethoxyphenyl-phosphine oxide, bis(2,4,6-trimethylbenzoyl)-phenyl-phosphine oxide and mixtures thereof.

4. A coating composition according to claim 2 wherein the clearcoat composition comprises
A) 0.1 to 30% by weight of one or more compounds comprising acrylate or methacrylate monomers or mixtures thereof having from 1 to 6 free-radically polymerizable groups per molecule;
B) 15 to 80% by weight of one or more compounds containing two or more ethylenically unsaturated, free radically polymerizable groups per molecule selected from the group consisting of urethane acrylates and methacrylates, polyester acrylates and methacrylates, melamine, acrylic amine, cellulose based acrylates and methacrylates and unsaturated polyesters;
C) 1.0 to 5.0% by weight of one or more photoinitiators;
D) 4.0-53.7% by weight of volatile organic solvent and;
E) 0.3-3.0% by weight of UVA and/or HALS, and
from 0-8.0% by weight of customary additives selected from the group consisting of adhesion promoters, flow aids, wetting aids and rheology modifiers and mixtures thereof,
where all weights are based on total coating composition weight.

5. A coating composition according to claim 1 wherein the solvent D) is selected from the group consisting of n-butyl propionate, n-propyl propionate, secondary butyl alcohol, isopropyl alcohol, propylene glycol methyl ether, propylene glycol tert-butyl ether, propylene glycol ethyl ether and mixtures thereof.

6. A coating composition according to claim 1 wherein the solvent D) is selected from a mixture of N-propyl propionate and monomethyl glycol ether, or n-propyl propionate and sec-butyl alcohol in a ratio of between 0.5:1 to 1:1.5.

7. A method for lowering the color of a cured clearcoat composition, cured by exposure to ultraviolet radiation, comprising
A) forming a coating composition from a mixture of
i) 0-50% by weight of one or more compounds comprising acrylate or methacrylate monomers or mixtures thereof having from one to six free-radically polymerizable groups per molecule,
ii) 30 to 99.9% by weight of one or more compounds containing two or more ethylenically unsaturated, free radically polymerizable groups per molecule and mixtures thereof, and mixtures of A) and B),
iii) from 0.10 to 10.0% by weight of one or more photoinitiators selected from the group consisting of alpha hydroxyl ketones, alpha amino ketones and bis-acyl phosphine oxides and mixtures thereof;
iv) 0.1-69.9% by weight of volatile organic solvent(s) selected from the group consisting of alcohols, ether alcohols, ether esters, propionates and mixtures thereof;
B) applying the clearcoat composition to a substrate; and
C) exposing the clearcoat composition on the substrate to ultraviolet radiation to form a cured coating on the substrate.

8. The method of claim 7, wherein the coating composition formed further comprises from 1-15% by weight of UVA and/or HALS selected from the group consisting of triphenyltriazines, oxalic acid anilides, 2,2,6,6-tetramethyl piperidine based HALS and mixtures thereof.

9. The method of claim 7, wherein the coating composition is formed using compound iii) selected from the group consisting of 1-hydroxy-cyclohexyl-phenyl ketone, 2-hydroxy-2-methyl-1-phenyl-propan1-one, 2,4,6-trimethylbenzoyl-diphenylphosphine oxide, a blend of 2,4,6-trimethylbenzoyl-diphenylphosphine oxide and 2-hydroxy-2-methyl-1-phenyl-propan1-one and poly[2-hydroxy-2-methyl-1-[4-(1-methylvinyl)phenyl]propan-1-one], 2,4,6-trimethylbenzoyl-ethoxyphenyl-phosphine oxide, bis(2,4,6-trimethylbenzoyl)-phenyl-phosphine oxide and mixtures thereof.

10. The method according to claim 7, wherein the coating composition formed comprises
i) 1.0 to 30% by weight of one or more compounds comprising acrylate or methacrylate monomers or mixtures thereof having from 1 to 6 free-radically polymerizable groups per molecule;
ii) 15 to 80% by weight of one or more compounds containing two or more ethylenically unsaturated, free radically polymerizable groups per molecule selected from the group consisting of urethane acrylates and methacrylates, polyester acrylates and methacrylates, melamine, acrylic amine, cellulose based acrylates and methacrylates and unsaturated polyesters;
iii) 1.0 to 5.0% by weight of one or more photoinitiators;
iv) 4.0 to 53.7% by weight of volatile organic solvent; and
v) 0.3-3.0% by weight of UVA and/or HALS,
where all weights are based on total coating composition weight.

11. A method according to claim 7 wherein, in step C, the coating is exposed to ultraviolet radiation for between 1 and 10 minutes.

12. A method according to claim 7 wherein the cured coating formed in step C has a minimum of 3300 kJ/m² prior to failure following WOM test conditions specified in SAE J1960 and a yellowing factor delta E, of from 0 to 2.0.

13. A method according to claim 7 wherein the coating is formed using as component iv) compounds selected from the group consisting of n-butyl propionate, n-propyl propionate, secondary butyl alcohol, isopropyl alcohol, propylene glycol methyl ether, propylene glycol tert-butyl ether, propylene glycol ethyl ether and mixtures thereof.

14. A method according to claim 7 wherein the coating is formed using as component iv) components selected from the group consisting of N-propyl propionate and propylene glycol methyl ether, or n-propyl propionate and sec-butyl alcohol. Mixtures of these solvents in a ratio of between 0.5:1 to 1:1.5.

15. A method according to claim 7 wherein the coating is cured with an irradiance level between 0.01 and 200 mW/cm² for a time of between 1 second and 30 minutes to obtain a low color, weatherable coating.

16. A method according to claim 7 wherein the coating is cured with an irradiance level of between 1 and 100 mW/cm² for a time of between 30 seconds and 10 minutes to obtain a low color, weatherable coating.

17. A method according to claim 15 wherein the coating is cured with a UV source providing UV irradiation with UVV:UVA of 1:1 or less, UVB:UVA of 1:1 or less, and UVC:UVA of 1:1 or less.

18. A method according to claim 15 wherein the coating is cured with a UV source providing UV irradiation with UVV:UVA of 1:1 or less, UVB:UVA of 1:1 or less, and with substantially no UVC.

19. A method according to claim 15 wherein the coating is cured with a UV source providing UV irradiation with UVV:UVA of 0.5:1 or less, UVB:UVA of 0.5:1 or less, and with substantially no UVC.

20. A method according to claim 15 wherein the coating is cured with a UV source providing UV irradiation with UVV:UVA of 1:1 or less, UVB:UVA of 1:1 or less, and with substantially no UVC.

21. A method according to claim 15 wherein the coating is cured with a UV source providing UV irradiation with UVV:UVA of 0.5:1 or less, UVB:UVA of 0.5:1 or less, and with substantially no UVC.
